(19) United States
(12) Patent Application Publication
(10) Pub. No.: US 2010/0169147 A1
(43) Pub. Date: Jul. 1, 2010

(54) Location-based queuing

(75) Inventors: Tony McCormack, Galway (IE); Neil O'Connor, Galway (IE); Joseph Smyth, Galway (IE)

Correspondence Address: BARNES & THORNBURG LLP, P.O. BOX 2786, CHICAGO, IL, 60690-2786, US

(73) Assignee: NORTEL NETWORKS LIMITED, St. Laurent (CA)

(21) Appl. No.: 12/346,373

(22) Filed: Dec. 30, 2008

(51) Int. Cl. G06Q 10/00; G01C 21/00

(52) U.S. Cl. 705/9; 701/300; 701/207

(57) ABSTRACT

Queuing to a mobile agents is accomplished by assigning each mobile agents to one of a plurality of location zones based on information received from a tracking system, and maintaining a plurality of location-specific queues of requests, each location-specific queue having one or more of the location zones associated therewith, and each location-specific queue being serviced only by those mobile agents whose assigned location zone matches a location zone of that location-specific queue. On receiving a location-based request for the services of a mobile agent, an optimum queue is selected for the request from among the plurality of location-specific queues based at least in part on a comparison between the request location and a location zone associated with the optimum queue, subject to a servicing constraint that a queue can only be selected as the optimum queue if at least one agent is currently servicing the queue.

### TECHNICAL FIELD

This invention relates to location-based queuing.

### BACKGROUND ART

It is known to queue requests to mobile agents, taking into account the relative positions of the request location and the agent. An example of such a system is disclosed in commonly-assigned US Patent Publication No. 2002-0077876 A1 (Kelly et al.), which discusses the allocation of requests to mobile agents such as taxicab drivers.

In Kelly's system, the area to be covered is divided into cells, so that each new request can be allocated to the cell in which it needs to be serviced. For every mobile agent there is a listing of all the cells in the area, and for each cell, the time at which that agent might be expected to be free to service an order in that cell.

Thus, if an agent (say a taxicab driver) takes on a job for which he is expected to become free in a particular cell (e.g. cell 165) at a particular time (e.g. 11.10), then based on known average journey time information from cell 165 to every other cell in the grid, the information for that driver can be updated to show that, for example, he is free to service an order in a cell adjacent to cell 165 at 11.11, whereas he may only be free to service an order in a distant cell at 11.32.

Kelly's system queues each request or order on the basis of its location, and assigns orders to mobile agents on the basis of the earliest available mobile agent to reach the location of the order.

An alternative system is known from US Patent Publication No. 2002-0065700 A1 to Powell et al. Powell describes assigning orders to a mobile workforce. In Powell's system, there are orders which are allocated in advance of a day's work to particular workers, and other pooled orders which can be assigned to any worker who has a slack period during the day.

In Powell's system, an order received during the working day will be a pooled order assigned to a geographical block. Workers are similarly allocated to a geographical block. When a pooled assignment is being assigned, it is given normally to a worker who is located in that same geographical block, or if no such worker is available, the search is expanded out to neighboring blocks until a worker is found whose schedule has a slack period.

Thus, while Kelly's system queues each order in its own location and uses the constantly updated file for each agent to determine which is the first available agent to reach that location and service that order, Powell looks for the geographically closest worker with a slack period in his or her schedule.

### DISCLOSURE OF THE INVENTION

There is provided a method of queuing to a plurality of mobile agents, the method comprising the steps of:
(a) receiving information regarding the location of one of said mobile agents and assigning said mobile agent to one of a plurality of location zones based on said received information;
(b) maintaining a plurality of location-specific queues of requests, each location-specific queue having one or more of said location zones associated therewith, and each location-specific queue being serviced only by those mobile agents whose assigned location zone matches a location zone of that location-specific queue;
(c) receiving a request for the services of a mobile agent, said request being associated with a request location;
(d) determining an optimum queue for said request from among said plurality of location-specific queues based at least in part on a comparison between said request location and a location zone associated with said optimum queue, subject to a servicing constraint that a queue can only be selected as said optimum queue if at least one agent is currently servicing said queue.

This method does not rely on computationally intensive travel times for each agent, but instead limits the servicing of each location-specific queue to those agents who are actually located in the zone or zones to which the queue itself relates. Requests which relate to a zone having no such available agents are moved into a queue for another zone, where agents are available.

Preferably, the method further includes the steps of receiving information regarding a change of said mobile agent's location, and dynamically updating the location zone assigned to said mobile agent, if necessary.

Preferably, one or more of said location-specific queues has an area associated therewith, the area comprising a plurality of zones, such that said one or more location zones are associated with said location-specific queue by virtue of falling within said area.

Thus, agents might be tracked to a location zone which is more granular than the area covered by a queue. For example, agents might be tracked from room to room, with a queue servicing all rooms on a given floor.

Optionally, the method can also further include the step of maintaining at least one skill-based queue having no location zones associated therewith, said skill-based queue being serviced by those mobile agents having an appropriate skillset match with requests in said skill-based queue.

Preferably, in such cases, said request received in step (c) is placed in at least one location-specific queue as well as in at least one skill-based queue, with multidimensional queuing being used to assign said request to an agent having a suitable location and skillset.

Optionally, at least one of said location-specific queues also has a skillset associated therewith in addition to the one or more location zones associated therewith, the queue being serviced only by those agents who are determined to have both an appropriate skillset match and the required matching assigned location zone.

Preferably, in such cases, the determination of an optimum queue for said request from among said plurality of location-specific queues is also based at least in part on a comparison between skill-based requirements of said request and said skillset associated with said at least one queue.

The method may also involve the steps of making a first determination as to whether an expected wait time for an agent to service said request from said optimum queue exceeds a threshold, and making a second determination as to whether another location-specific queue exists having an acceptable wait time and providing an acceptable degree of proximity between its associated location zone or zones and said request location.

Preferably, in the event that both said first and second determinations are positive, said request is moved to the other location-specific queue identified in the second determination.

Optionally, while said request is in said optimum queue, the method can include determining that an agent has become available to service a location-specific queues which was not serviced at the time said optimum queue was determined, and moving said request if said another of said queues is preferable to the currently identified optimum queue.

Thus, if a zone in which a request originates is not serviced by any suitable agents at the time the request is processed, the request will be queued in the queue relating to another zone. However, if an agent moves into the zone of the request while the request is still queuing, the request can be moved into the queue relating to this zone.

Optionally, in step (d) a proximity constraint may be imposed on said comparison between said request location and the queues' associated location zones, whereby an optimum queue must have its associated zones within a threshold of proximity to said request location.

This prevents a request being queued to a zone which is determined to be too far away, such as a queue relating to a remote building or a different site. This choice may be made based on a determination that it is preferable to await a closer agent, or to leave the request unanswered, than to allocate it to an agent at such a remote location.

Thus, if no acceptable determination can be made due to the unavailability of any queue satisfying both the servicing constraint and the proximity constraint, an optimum queue may be determined without regard to said servicing constraint.

There is also provided a computer program product comprising a computer readable medium encoding instructions which when executed in a computing system are effective to cause said computing system to perform the aforesaid methods.

We also provide a queuing system for queuing to a plurality of mobile agents, comprising:
(a) a mobile agent resource record which records an assignment of one of a plurality of location zones to one of said mobile agents based on information received regarding the location of said mobile agent;
(b) a plurality of location-specific queues of requests, each location-specific queue having one or more of said location zones associated therewith, and each location-specific queue being serviced only by those mobile agents whose assigned location zone matches a location zone of that location-specific queue;
(c) a request record which records a received request for the services of a mobile agent, together with a request location associated with said request;
(d) a queue allocation system which is configured to determine an optimum queue for said request from among said plurality of location-specific queues based at least in part on a comparison between said request location and a location zone associated with said optimum queue, subject to a servicing constraint that a queue can only be selected as said optimum queue if at least one agent is currently servicing said queue.

The system may also include the tracking application which tracks the mobile agents.

Elements of the system may suitably be embodied in appropriately programmed computer systems, and in particular contact center queuing systems may be adapted for use in queuing to mobile agents as described herein.

### BRIEF DESCRIPTION OF THE DRAWINGS

The invention will now be further illustrated by the following descriptions of embodiments thereof, given by way of example only with reference to the accompanying drawings, in which:

FIG. 1 is a schematic floor layout of three floors of a building;

FIG. 2 is a block diagram of a system for queuing requests to agents and a system for tracking such agents;

FIG. 3 is a representation of the data entries maintained for agents in a mobile agent database suitable for use in the queuing system of FIG. 2;

FIG. 4 is a representation of the data entries maintained for agent availability in respect of a plurality of location-specific queues, suitable for use in the queuing system of FIG. 2;

FIG. 5 is representation of the data entries maintained for agent availability in respect of a plurality of skill-based queues, suitable for use in the queuing system of FIG. 2;

FIG. 6 is a block diagram of a further system for queuing requests to agents and a system for tracking such agents

FIG. 7 is a representation of the data entries maintained for agent availability in respect of a plurality of combined location and skill-based queues, suitable for use in the queuing system of FIG. 6; and

FIG. 8 is a flowchart of a method of queuing requests to agents.

### DETAILED DESCRIPTION OF PREFERRED EMBODIMENTS

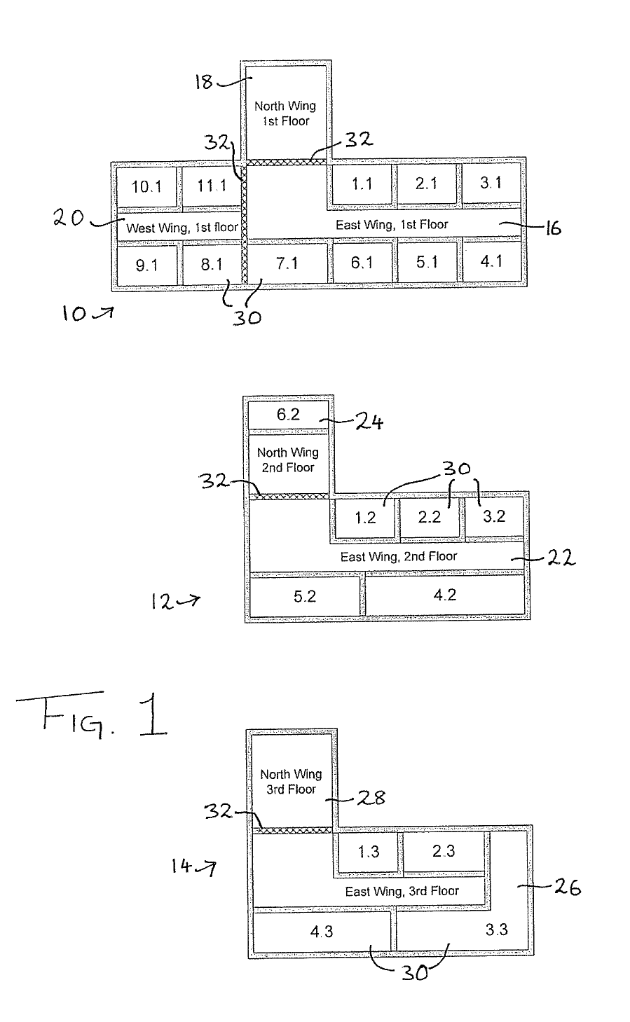

FIG. 1 shows a schematic floor plan of a three-storey hospital building having a first floor 10, a second floor 12 and a third floor 14. The first floor has an east wing 16, a north wing 18 and a west wing 20. The second floor has an east wing 22 and a north wing 24. The third floor similarly has an east wing 26 and a north wing 28.

A number of rooms 30 are defined on each floor, with each room having a two-part identifier in the form {Room Number}.{Floor Number}; thus the identifier 4.3 denotes Room 4, 3rd Floor.

The boundaries between the different wings on each floor are denoted by cross-hatched lines 32. Key personnel moving from one wing to another are detected as they cross these boundaries, or as they move from one floor to another, or as they leave the premises. The detection can be achieved by any suitable technology. Exemplary technology would include but is in no way limited to: radio frequency identification (RFID) readers detecting RFID tags worn by personnel; global positioning for satellites (GPS), assuming sufficiently good coverage and resolution is achievable in a particular environment; manual logging of changes in position by the personnel themselves or by others; magnetic card readers; voice, retinal or other biometric detectors; photographic or video recognition, etc.

A location tracking application (i.e. software running on an appropriately configured computer system) maintains a database of the key personnel and their current location on the premises. For the purposes of this description, the personnel are regarded as “mobile agents”. Such personnel could include (in the context of a hospital) doctors, nurses, porters, technicians, food delivery staff, managers, administrators, paramedics, drivers and counselors. Each such person is therefore located within the hospital building to within the accuracy of a particular wing (e.g. East Wing, 2nd Floor).

The example of a hospital located over three floors of the same building is only for illustrative purposes. An environment can encompass several buildings or no buildings at all. In other environments and other applications, the types of mobile agent may be different and may all be of a single type (e.g. taxicab drivers located in different parts of a city; or network specialists, software specialists and printer repair staff distributed around the buildings of a university campus).

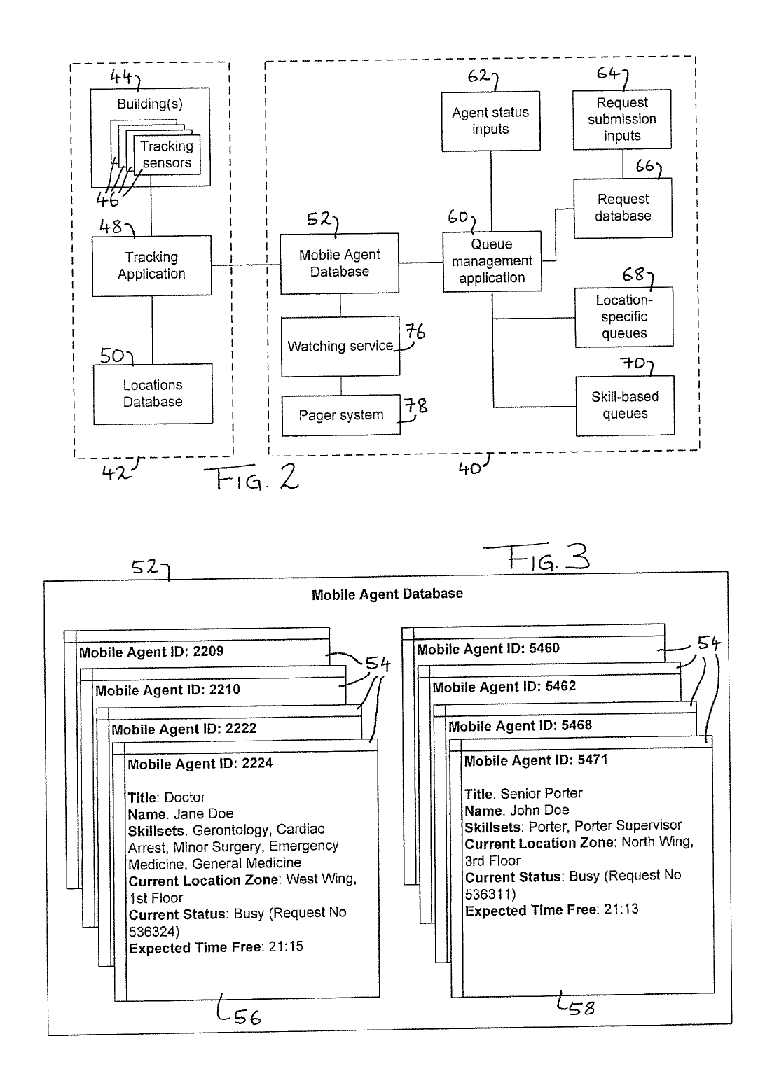

FIG. 2 is a block diagram showing the major functional and infrastructural components of a queuing system 40 for queuing to a plurality of mobile agents, such as in the hospital of FIG. 1, alongside a tracking system 42 which includes a representation of the building 44 having sensors 46 (or other inputs to record changes of location of mobile agents as discussed previously). The sensors communicate with a tracking application 48 which uses a locations database 50 to translate sensor input into a location zone (such as East Wing, 2^{nd} Floor).

The queuing system 40 includes a mobile agent database 52, which includes entries for each mobile agent on the premises, as will now be described further.

Referring additionally to FIG. 3 a mobile agent database is represented having numerous entries, one for each mobile agent currently on the premises (for simplicity only a small number of entries are indicated). FIG. 3 schematically the contents of the data structure maintained for two such mobile agents 56,58, one of whom is a doctor 56, and the other of whom is a senior porter 58. For each such agent the title or position and name are recorded (along with any other useful bibliographic information required).

The skillset(s) which the agent is equipped to handle are stored in the database for each agent. For the doctor 56, these skillsets include numerous medical specialties and abilities. For the senior porter, there are only two skillsets, namely that of porter and that of porter supervisor.

The granularity of skillset is a matter of designer's choice, and will typically be tailored to the nature of requests which the agents are required to service. Thus, while any task requiring a porter can be dealt with by any one of the trained porters in this hospital (so there is a single “porter” skillset), it is not the case that any doctor can be relied on to handle a medical specialty (in general if a gerontologist is called for, it is little use for a tropical medicine specialist to attend; however, if a patient suffers a heart attack, any person trained to an appropriate level in the “cardiac arrest” specialty will suffice, regardless of whether they are also a gerontologist, a nurse trainee, or a hospital administrator).

For each mobile agent, the current location zone is recorded and kept current by the tracking application 48 (FIG. 2), so that at all times the most recently recorded location zone for each agent in the database 52 is indicated in this field of that agent's database entry.

The database also records the current status of the agent (which may be as simple as “busy” or “idle/free”, but in this case also includes an indication of the task or request in which that agent is currently engaged. The status is maintained by a queue management application 60 (FIG. 2) based on agent status inputs 62 received from the agents via any suitable communications system, such as a two-way pager allowing an agent to indicate that they are finished their current task, or a handheld device with wireless communications facility, or even one of a number of RFID readers or magnetic scanners located around the hospital which the agent can activate to signal that they are now free. The agent status inputs can be manual, for example with doctors and porters calling a central operator asking the operator to update their current status. Presence information, such as SIP Presence, can also be used as a provider of status information as well as basic telephony availability—e.g. if on the phone, an agent could be inferred to be unavailable (or perhaps available for interruption if a high priority request needs their attention).

Finally, referring back to FIG. 3, the database records the time at which the agent is expected to become free, based on manual inputs or on standard timings for different types of task. For example, a porter who is servicing a request to move a patient from room 5.1 on the first floor to the operating theater 4.3 on the third floor might be expected to become free for the next task eight minutes later, allowing more accurate scheduling of waiting requests.

Requests for services (such as a request to transfer a patient to theater, or a cardiac arrest emergency) are received by any suitable system as request submission inputs 64. In many cases a range of systems will contribute to these inputs, including emergency call buttons, human telephone operators, pager inputs, and operating theater schedules, to name but a few.

Details of the requests are recorded in a request database 66 from which they are processed by the queue management application 60. In particular, the request will include a location indicator, either explicitly or implicitly. As an example of an explicit indicator, a human operator may indicate the need for a gerontologist in a particular room, or a cardiac arrest alarm may be pressed in a corridor in a given wing of the hospital. As an example of an implicit indicator, the request may be for an additional theater nurse to attend an operation, in which case it will be implied that the request relates to the operating theater in room 4.3.

The locations of such requests are translated to location zones (in this case one of the 7 wings over the hospital's three floors) either by intelligence attached to the database, or by an operation on the data received. For example, queue management application may pass each new request entry in the request database 66 to the locations database 50, with the locations database returning the location zone.

In addition to the location information in the request, there will also be recorded in the requests database relevant required skills, such as porter, gerontologist, etc.

The queue management system 60 of FIG. 2 assigns requests to mobile agents using multidimensional queuing: requests are queued to one of a number of location-specific queues 68 as well as to one or more skill-based queues 70. Matches are required both against location and against skillset in order for a request to be assigned to an agent.

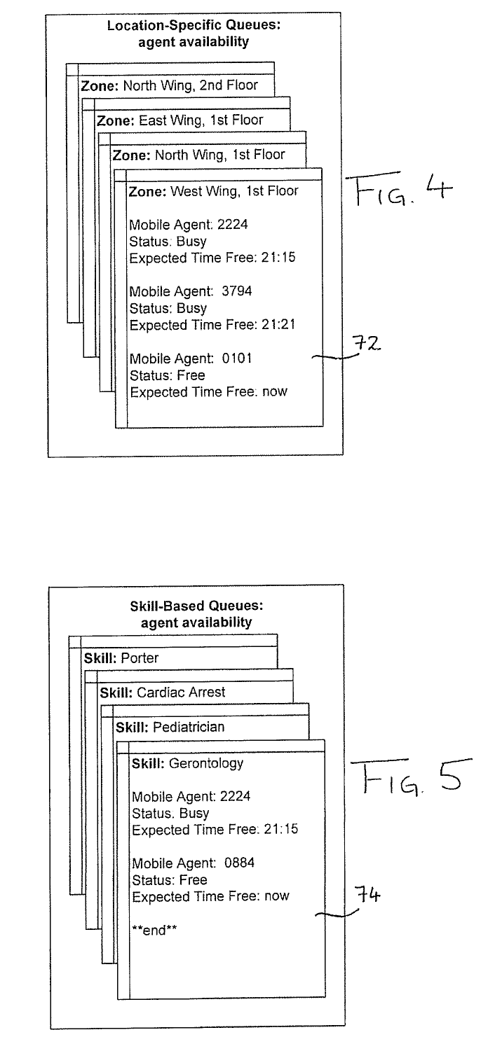

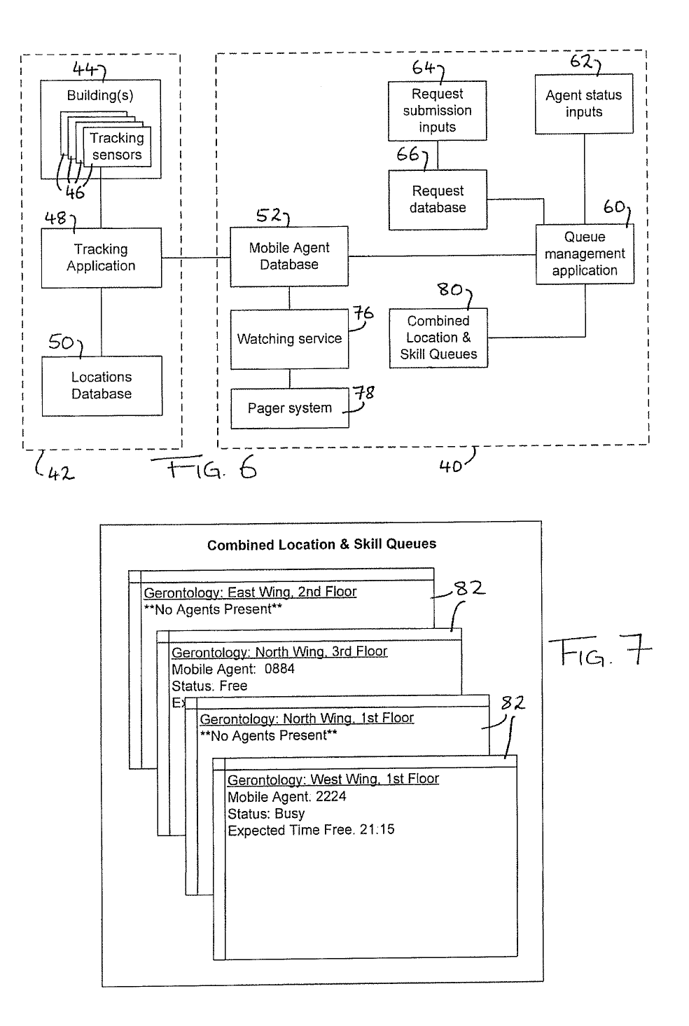

For each type of queue the queue management application maintains a listing of agents qualified to service requests in that queue. Such an agent listing is shown in FIG. 4 for some location-specific queues, while FIG. 5 shows a similar listing for some skill-based queues.

Referring additionally it can be seen from FIG. 4 that the doctor (ID 2224) discussed in relation to FIG. 3 is indicated to be available to service requests held in the queue 72 for the West Wing, 1st Floor, along with other mobile agents located in that part of the hospital.

Referring additionally to FIG. 5, the same doctor is also listed as available to service requests in the queue 74 for the Gerontology skillset, along with just one other colleague (ID 0884).

The skilled person will be familiar with multidimensional queuing, as used to match a request against several variables.

The location-specific queues in this embodiment do not allow the agents to be available to service different zones. Instead, requests which cannot be serviced in the most preferred zone are instead queued against a next most preferred zone. Thus, if Doctor 2224 is in the West Wing, 1st Floor, while the other gerontologist, Doctor 0884 is in the North Wing, 3rd Floor, then a request for a gerontologist received from room 6.1 (East Wing, 1st Floor) will fail to find a suitable match. The request will then instead be switched to an alternative location-specific queue in which a match can be found, according to rules as to the relationship between different location zones. Note that the request could be queued to both sets of queues simultaneously (which may be preferable in practice) allowing it to be serviced by the optimal agent should one become available.

The rules as to alternate locations can be stored in the queue management application, or can be automated based on the identifiers assigned to zones. For example, failure to find an agent in (East Wing, 1st Floor) can cause the queue management application to sequentially look at every other zone matching the pattern (* Wing, 1st Floor), where * represents a wild card.

Alternatively, the locations database can be consulted to find the best alternative zone, which might be provided with access to a representation of the environment allowing more accurate proximity relationships to be determined. Thus, in a sprawling hospital complex where no suitable agents are found for the zone called “Alpha Ward, Ground Floor, Aspen Building”, a locations database might ignore the zone called “Omega Ward, Ground Floor, Aspen Building” in favor of the much closer zones called “1st Floor, Maple Building” and “Basement, Maple Building”.

Rather than selecting a single optimal queue, as has been shown for simplicity and ease of understanding, the system may attempt to queue to the optimal location and, if no agents are available or no agents become free in a suitable period of time, the request can then be queued to one or more additional locations (while maintaining its place in the original queue).

On finding a suitable queue or queues, the request is placed in the queue, and once an agent becomes available, such as by doctor 2224 signaling that she is finished her current consultation to agent status inputs system 62, the queue management application updates that doctor's status to “Request Assigned”, along with the request ID number, and a watching service 76 notes this status and instructs a pager system 78 to page details of the newly assigned request to the doctor. Once the doctor accepts the request (such as by a two-way pager or PDA equipped with unified communication software), the status is updated to “Busy” and the expected free time is updated accordingly. The request is cleared from both the location-specific queue and the skill-based queue.

When the doctor in fact moves from the current location of the West Wing to the new location of the East Wing on the 1st Floor, the tracking application 48 updates the mobile agent database 52 accordingly. This change of location is noted in the location-specific queues accordingly, in order that in the case of an emergency such as a cardiac arrest in the East Wing, the doctor will be immediately identifiable as being available to service such an emergency.

FIG. 6 shows an alternative embodiment which is identical to that of FIG. 2 (and in which like components are designated with identical reference numerals) except for the replacement of the location-specific queues and the skill-based queues with combined location and skill queues 80. This embodiment employs “flat” or one-dimensional queuing, so that a location zone-specific skillset is maintained for each skill and location zone.

FIG. 7 shows a small subset of the queues 82, represented in terms of agent availability to service these queues, for one skillset (Gerontology) in four of the total seven zones. As there are only two gerontologists in the building, there are entries showing the availability of an agent in the skillsets “Gerontology: North Wing, 3rd Floor” and “Gerontology: West Wing, 1st Floor”. All of the other “Gerontology: . . . ” skillsets show no agents available.

A request for a gerontologist in either the North Wing, 3rd Floor or the West Wing, 1st Floor will be queued directly in that skillset. However, a request for the services of a gerontologist in (say) the North Wing, 1st Floor will not be queued to that location's gerontology skillset as it has no agents to service it; instead the request will be queued to the most appropriate of the two areas which are serviced.

As with known queuing mechanisms, priorities may be assigned to requests and skill levels may be assigned to agents to assist in queuing decisions.

The examples given in relation to a very scarce resource can now be compared with a resource for which good numbers of agents may exist in each location zone, for example, general nurses (for whom there may be dozens on duty at any time in each wing of the hospital). In such cases, the optimum location-specific queue (or combined location and skill queue) for a request will almost inevitably be the zone in which the request originated. However, the optimum queue can be ignored if it is determined that the expected wait time exceeds a threshold. Alternatively, the request may be queued to multiple queues simultaneously over time. For a patient submitting a general nursing request, this threshold might be quite long (say fifteen minutes), but any requests which are not expected to be dealt with in that time will be looked at to see if another location exists in which the request can be queued, provided there is an acceptable proximity between the two zones. In effect this would result in the request being paged to a nurse in another, less busy wing of the hospital.

However, for other types of request, such as a cardiac arrest, any expected wait time greater than “immediate” might exceed the acceptable threshold. For example, if the sole cardiac arrest team in a particular zone is already on a call to one patient, then a second request for a cardiac arrest team in that zone will exceed the waiting threshold. Unless the team is expected to be free very soon with a high degree of certainty, the second request will be placed in the queue of a neighboring zone where it can be notified immediately to an idle cardiac arrest team.

The processes and functional components illustrated in FIGS. 2 and 6 are generally carried out by appropriate computer software running on general purpose computers which may be stand-alone units or may be distributed computing systems, and similarly, the data structures illustrated in FIGS. 3, 4, 5 and 7 will be managed by and operated on my appropriate software.

Software is generally carried as instructions on a machine-readable carrier of some sort, such as a magnetic or optical disk, a solid state memory, or any other suitable carrier. It may be hard-wired into an electronic circuit or implemented as firmware in an appropriate processing system.

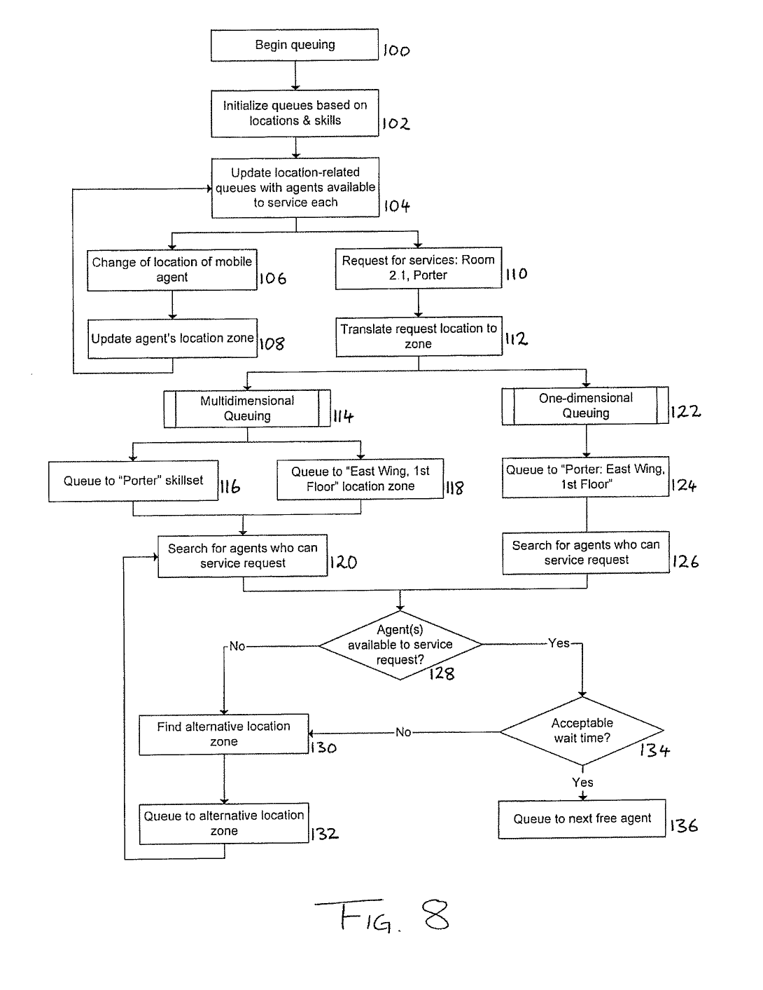

FIG. 8 provides a flowchart showing the high level operations that may be carried out by such software.

The queuing process begins in step 100, with the queues being initialized based on the locations and skills programmed by the system designers or supervisors, step 102. A maintenance interface can be provided to allow updating of locations and skillsets and the creation or deletion of queues.

All of the queues which are location-related (whether they be location-specific queues of a multidimensional queuing embodiment or combined skill and location queues of a one-dimensional queuing embodiment) are updated, step 104, with the currently available agents to service each location based on the information held in the mobile agent database.

The agent location information is kept updated as described previously, and so when there is a change of location of mobile agent detected by the location tracking application, step 106, the agent's location zone is updated accordingly, step 108, following which step 104 is repeated to update the agents available for each queue.

In step 110, a request for services is received, for example a request for a porter in room 2.1. This room is known to be in the East Wing on the 1st Floor and so the request is recorded in the request database 66 with this zone, step 112.

In a multidimensional queuing application, 114, the request is added to two queues: one for the “porter” skillset, step 116, and a queue to the specified location zone, step 118. A search is then performed to ensure that there is at least one porter servicing this zone, step H 120. This search would happen periodically also—i.e. the request could be queued when there are agents in the location, but this could change. Also initially availability could be adequate, but higher priority requests could take precedence and so a different zone would need to be selected in addition to the optimum zone.

Alternatively, in a one-dimensional queuing embodiment 122, the request is queued to the combined location and skill queue for porters in the specified zone, step 124. As with the multidimensional queuing embodiment, a search is then performed to ensure that there is at least one porter servicing this zone, step 126.

The results of the search in step 120 or 126 are evaluated in decision 128. If it is determined that no suitable agents are servicing the zone in question, the process moves to step 130, and the queuing manager application 60 (optionally in conjunction with the locations database 50) identifies an alternative location zone. The request is placed in the queue for that alternative zone, step 132, and is again subject to a check for an agent servicing the specified zone, step 120 (or 126). Again as discussed earlier, queuing to multiple queues can be supported.

When the determination in decision 128 is positive, a further optional check is made as to whether the wait time is acceptable, step 134. As indicated previously, the threshold for “acceptable wait time” can vary from request to request or from skillset to skillset, or from location to location (e.g. in some embodiments, higher-paying customers in certain areas may have a different service level agreement requiring faster service). If the wait time is not acceptable, the process moves to step 130, seeking a suitable alternative location zone to queue the request, normally based on availability of agents (i.e. new wait time) and proximity. If, however, the wait time does not exceed a threshold, the request is held in the queue and is allocated or routed to the next free agent once it reaches the top of the queue, step 136.

The invention is not limited to the embodiments described herein which may be varied or modified without departing from the scope of the invention.

We claim:

1. A method of queuing to a plurality of mobile agents, the method comprising the steps of:
(a) receiving information regarding the location of one of said mobile agents and assigning said mobile agent to one of a plurality of location zones based on said received information;
(b) maintaining a plurality of location-specific queues of requests, each location-specific queue having one or more of said location zones associated therewith, and each location-specific queue being serviced only by those mobile agents whose assigned location zone matches a location zone of that location-specific queue;
(c) receiving a request for the services of a mobile agent, said request being associated with a request location;
(d) determining an optimum queue for said request from among said plurality of location-specific queues based at least in part on a comparison between said request location and a location zone associated with said optimum queue, subject to a servicing constraint that a queue can only be selected as said optimum queue if at least one agent is currently servicing said queue.

2. A method as claimed in claim 1, further comprising adding said request to said optimum queue.

3. A method as claimed in claim 2, further comprising the step of assigning said request to one of said mobile agents based on queuing rules.

4. A method as claimed in claim 1, further comprising communicating with an agent tracking system to determine a current location of said mobile agent

5. A method as claimed in claim 1, further comprising the steps of receiving information regarding a change of said mobile agent's location, and dynamically updating the location zone assigned to said mobile agent, if necessary;

6. A method as claimed in claim 1, wherein said information received in step (a) directly identifies one of said plurality of location zones.

7. A method as claimed in claim 1, wherein one or more of said location-specific queues has an area associated therewith, the area comprising a plurality of zones, such that said one or more location zones are associated with said location-specific queue by virtue of falling within said area.

8. A method as claimed in claim 1, further comprising the step of maintaining at least one skill-based queue having no location zones associated therewith, said skill-based queue being serviced by those mobile agents having an appropriate skillset match with requests in said skill-based queue.

9. A method as claimed in claim 8, wherein said request received in step (c) is placed in at least one location-specific queue as well as in at least one skill-based queue, with multidimensional queuing being used to assign said request to an agent having a suitable location and skillset.

10. A method as claimed in claim 1, wherein at least one of said location-specific queues also has a skillset associated therewith in addition to the one or more location zones associated therewith, the queue being serviced only by those agents who are determined to have both an appropriate skillset match and the required matching assigned location zone.

11. A method as claimed in claim 10, wherein in step (e), said determination of an optimum queue for said request from among said plurality of location-specific queues is also based at least in part on a comparison between skill-based requirements of said request and said skillset associated with said at least one queue.

12. A method as claimed in claim 2, further comprising the steps of making a first determination as to whether an expected wait time for an agent to service said request from said optimum queue exceeds a threshold, and making a second determination as to whether another location-specific queue exists having an acceptable wait time and providing an acceptable degree of proximity between its associated location zone or zones and said request location.

13. A method as claimed in claim 12, wherein in the event that both said first and second determinations are positive, moving said request to said another location-specific queue.

14. A method as claimed in claim 2, further comprising the steps of, while said request is in said optimum queue, determining that an agent has become available to service a location-specific queues which was not serviced at the time said optimum queue was determined, and moving said request if said another of said queues is preferable to the currently identified optimum queue.

15. A method as claimed in claim 1, wherein in step (d) a proximity constraint is imposed on said comparison between said request location and the queues' associated location zones, whereby an optimum queue must have its associated zones within a threshold of proximity to said request location.

16. A method as claimed in claim 4, wherein if no acceptable determination can be made due to the unavailability of any queue satisfying both the servicing constraint and the proximity constraint, an optimum queue is then determined without regard to said servicing constraint.

17. A computer program product comprising a computer readable medium encoding instructions which when executed in a computing system are effective to cause said computing system to perform a method of queuing to a plurality of mobile agents, by:
(a) receiving information regarding the location of one of said mobile agents and assigning said mobile agent to one of a plurality of location zones based on said received information;
(b) maintaining a plurality of location-specific queues of requests, each location-specific queue having one or more of said location zones associated therewith, and each location-specific queue being serviced only by those mobile agents whose assigned location zone matches a location zone of that location-specific queue;
(c) receiving a request for the services of a mobile agent, said request being associated with a request location;
(d) determining an optimum queue for said request from among said plurality of location-specific queues based at least in part on a comparison between said request location and a location zone associated with said optimum queue, subject to a servicing constraint that a queue can only be selected as said optimum queue if at least one agent is currently servicing said queue.

18. A queuing system for queuing to a plurality of mobile agents, comprising:
(a) a mobile agent resource record which records an assignment of one of a plurality of location zones to one of said mobile agents based on information received regarding the location of said mobile agent;
(b) a plurality of location-specific queues of requests, each location-specific queue having one or more of said location zones associated therewith, and each location-specific queue being serviced only by those mobile agents whose assigned location zone matches a location zone of that location-specific queue;
(c) a request record which records a received request for the services of a mobile agent, together with a request location associated with said request;
(d) a queue allocation system which is configured to determine an optimum queue for said request from among said plurality of location-specific queues based at least in part on a comparison between said request location and a location zone associated with said optimum queue, subject to a servicing constraint that a queue can only be selected as said optimum queue if at least one agent is currently servicing said queue.
